(19) United States
(12) Patent Application Publication
(10) Pub. No.: US 2018/0357040 A1
(43) Pub. Date: Dec. 13, 2018

(54) IN-VEHICLE INFOTAINMENT WITH MULTI-MODAL INTERFACE

(71) Applicant: Mitsubishi Electric Automotive America, Inc., Mason, OH (US)

(72) Inventors: Jacek Spiewla, Northville, MI (US); Gareth Williams, Northville, MI (US)

(21) Appl. No.: 15/618,931

(22) Filed: Jun. 9, 2017

(51) Int. Cl. G06F 3/16; G06F 3/01; G10L 15/22; G06F 3/0488

(52) U.S. Cl. CPC G06F 3/167; G06F 3/012; G06F 3/013; G10L 2015/223; G10L 15/22; G06F 3/0488; G06F 3/017

(57) ABSTRACT

An infotainment system for a vehicle is provided. The system includes a plurality of touch sensitive displays, a speaker system, at least one physical input control, a plurality of microphones, a gesture input system, a head and eye tracking system and a computing system. The various input systems are used to interact with the infotainment system. The system provides feedback to vehicle occupants using the displays and audio information.

### BACKGROUND

In-Vehicle Infotainment (IVI) systems control numerous functions within a car. For example, infotainment systems may control climate control systems, navigation systems and music systems. Additionally, infotainment systems control various applications, such as weather applications, messaging applications and video playback applications. Some applications may be built into the infotainment system. Other applications may be sent to the infotainment system from a device such as a smartphone. Infotainment systems may connect to the internet or other network using a built in wireless network interface, such as a cellular radio, or may connect to another device, such as a smartphone, which then connects to the internet. An infotainment system can connect to a device, such as a smartphone, using a cable, Wi-Fi, Bluetooth or other connection interface.

Infotainment systems are increasingly packaging more touch sensitive displays and fewer physical controls. Today, it is commonplace for infotainment systems to have one or more displays located in the instrument cluster area, in front of the driver. An additional display or multiple displays may be located in the center stack area of the dashboard, between the driver and the front passenger. Likewise displays may be located in front of one or more passengers. For example, the front passenger may have a display located in front of them on the dashboard. The rear passengers may have displays located in front of them, on the backs of the front seats. In some vehicles, displays for the rear passengers may hang from the ceiling of the vehicle.

As the number of displays and display sizes continues to expand, the complexity of using multi-display, content-rich infotainment systems while driving increases. In some instances, the number of displays may contribute to longer eyes-off-the-road times as a driver interacts with the displays. Additionally, passengers may have a difficult time putting the vehicle systems and applications they want to see on the intended display.

Additionally, vehicles contain increasingly complex safety and automation systems. Such systems include lane departure warning systems, forward collision warning systems, driver drowsiness detection systems, and pedestrian warning systems. Traditional vehicle systems such as door open systems and engine warning systems contribute to the number and complexity of systems providing feedback to a driver and other vehicle occupants.

### BRIEF SUMMARY

In one embodiment, an infotainment system for a vehicle is provided. The system includes a plurality of touch sensitive displays, a speaker system, at least one physical input control, a plurality of microphones, a gesture input system, a head and eye tracking system and a computing system. The computing system is connected to the plurality of touch sensitive displays, the physical input control, the microphones, the gesture input system and the head and eye tracking system. The computing system includes a processor and a computer-readable medium storing computer-executable instructions thereon, that when executed by the processor, perform a number of steps. The steps include recognizing a voice command received by the plurality of microphones. The system determines an object of interest by performing at least one of: 1) detecting a user's touch input on at least one of the physical input control and the touch sensitive displays; 2) identifying, with the gesture input system, a direction of a gesture made by the user; 3) identifying, with the head and eye tracking system, an object toward which the eye gaze position of the user is directed; 4) identifying, by the voice command, the object upon which the user intends to take action. The system identifies, with at least one of the plurality of touch sensitive displays, the physical input control, the microphones, the gesture input system and the head and eye tracking system a location of the user within the vehicle. Additionally, the system displays, on the touch sensitive display proximate to the user, a visual feedback to the voice command. In some embodiments, through the speaker system, the system provides audible feedback through speech or other non-verbal audio such as tones, beeps, etc.

In another embodiment, a computer readable medium storing computer executable instructions thereon is provided. The instructions are executed by a processor in an infotainment system including a plurality of touch sensitive displays, a speaker system, at least one physical input control, a plurality of microphones, a gesture input system, a head and eye tracking system and a computing system connected to the plurality of touch sensitive displays, the speaker system, the physical input control, the microphones, the gesture input system and the head and eye tracking system. The steps include detecting a voice command received by the plurality of microphones. The system determines an object of interest by performing at least one of: 1) detecting a user's touch input on at least one of the physical input control and the touch sensitive displays; 2) identifying, with the gesture input system, a direction of a gesture made by the user; 3) identifying, with the head and eye tracking system, an object toward which the eye gaze position of the user is directed; 4) identifying, by the voice command, the object upon which the user intends to take action. The system identifies, with at least one of the plurality of touch sensitive displays, the physical input control, the microphones, the gesture input system and the head and eye tracking system a location of the user within the vehicle. Additionally, the system displays, on the touch sensitive display proximate to the user, a visual feedback to the voice command. In some embodiments, through the speaker system, the system provides audible feedback through speech or other non-verbal audio such as tones, beeps, etc.

In yet another embodiment, a method of operating an infotainment system for a vehicle is provided. The infotainment system comprising a plurality of touch sensitive displays, a speaker system, at least one physical input control, a plurality of microphones, a gesture input system, a head and eye tracking system and a computing system connected to the plurality of touch sensitive displays, the speaker system, the physical input control, the microphones, the gesture input system and the head and eye tracking system. The method includes detecting a voice command received by the plurality of microphones. Determining an object of interest by performing at least one of: 1) detecting a user's touch input on at least one of the physical input control and the touch sensitive displays; 2) identifying, with the gesture input system, a direction of a gesture made by the user; 3) identifying, with the head and eye tracking system an object toward which the eye gaze position of the user is directed; 4) identifying, by the voice command, the object upon which the user intends to take action. Identifying, with at least one of the plurality of touch sensitive displays, the physical input control, the microphones, the gesture input system and the head and eye tracking system a location of the user within the vehicle. Displaying, on the touch sensitive display proximate to the user, a visual feedback to the voice command. In some embodiments, through the speaker system, the system provides audible feedback through speech or other non-verbal audio such as tones, beeps, etc.

### BRIEF DESCRIPTION OF THE SEVERAL VIEWS OF THE DRAWING(S)

FIG. 1 is a diagram illustrating an exemplary interior of a vehicle including an infotainment system;

FIG. 2 is a system diagram depicting exemplary components in a vehicle infotainment system.

FIG. 3 is a plan view diagram illustrating an exemplary interior of a vehicle including an infotainment system;

FIG. 4 is a flowchart illustrating an exemplary method for controlling a vehicle infotainment system;

FIG. 5 is a flowchart illustrating an exemplary method for querying a vehicle infotainment system; and

FIG. 6 is a block diagram of a processing system according to one embodiment.

### DETAILED DESCRIPTION

The following detailed description is exemplary in nature and is not intended to limit the disclosure or the application and uses of the disclosure. Furthermore, there is no intention to be bound by any expressed or implied theory presented in the preceding background and brief description of the drawings, or the following detailed description.

This disclosure relates to managing increasingly complex in-vehicle infotainment, safety and automation systems. In certain embodiments, a multi-modal interface is provided for a user to interact with an in-vehicle infotainment system. As described below, in some embodiments the multi-modal interface may include microphones and a speech recognition system, gesture input sensors and a gesture recognition system, head and eye tracking sensors and a head position and eye gaze direction measurement system, physical input controls and a physical control interpreter, and touch-sensitive displays and a touch sensitive display input interpreter. One or more of these input systems may be combined to provide the multi-modal interface.

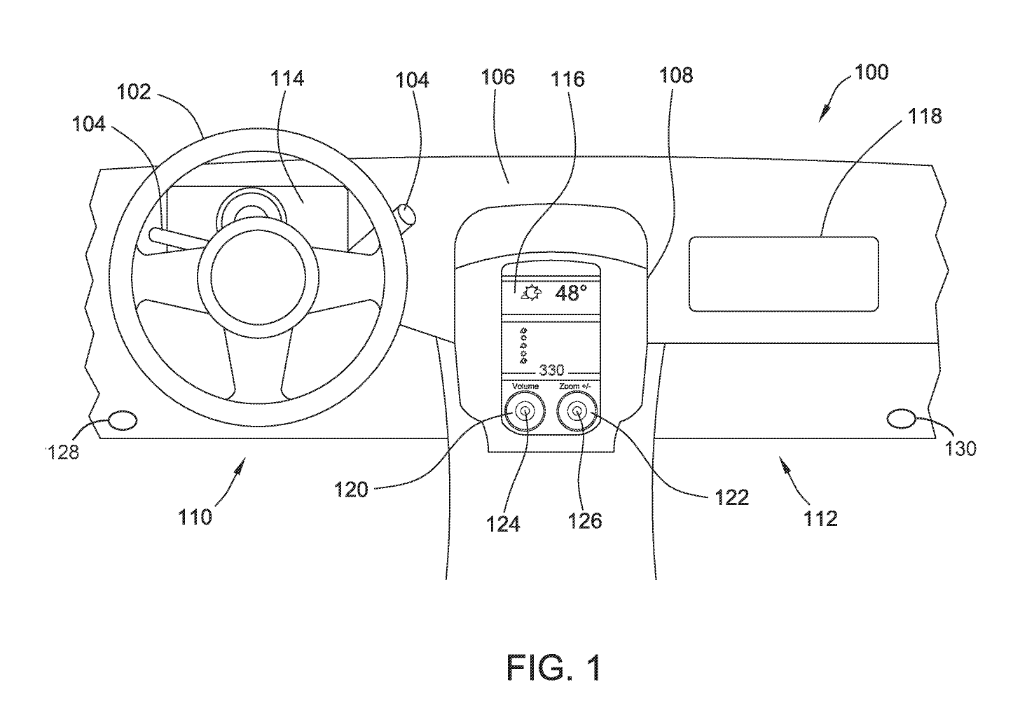

FIG. 1 is a diagram illustrating an exemplary interior of a vehicle. The vehicle interior 100 includes common vehicle components such as a steering wheel 102, control levers 104 and dashboard 106. A center stack 108 is located between the driver position 110 and front passenger position 112. In the illustrated embodiment, three displays are provided. Each of the displays can be touch sensitive or non-touch sensitive. A first display is the instrument cluster display 114, which in front of the driver position 110. A second display is the center stack display 116 located in the center stack 108. A third display is the front passenger display 118 located in front of the front passenger position 112. Each of the three illustrated displays may comprise multiple individual displays. For example, in some embodiments, the center stack display 116 may be comprised of multiple individual displays.

Additionally, the vehicle interior 100 includes a first physical input control 120 and a second physical input control 122. As illustrated, physical input controls 120 and 122 are knobs. In other embodiments, the controls can be any appropriate physical input, such as a button or slider. The physical input controls 120 and 122 can be mounted on the center stack display 116 or may be mounted onto the passenger display 118. In some embodiments, when mounted on a display, the center of the physical input controls 120 and 122 is open, allowing the display to be visible. In other embodiments, the physical input controls 120 may be moveable to any position on a display, such as center stack display 116 and passenger display 118. For example, physical input controls 120 and 122 include physical input control display areas 124 and 126. In some embodiments, the physical input control display areas 124 and 126 are part of another screen, such as the center stack display 116. In other embodiments, physical input control display areas 124 and 126 each have a physical input control display separate from other displays in the vehicle. In this way, physical input controls 120 and 122 can have displays 124 and 126 mounted on them. Physical input controls 120 and 122 can be dynamically assigned a function, based either on the application being displayed or on a user command. The physical input control displays 124 and 126 can display an indication of the function assigned to their respective physical input controls 120 and 122.

Each of the displays can display in-vehicle infotainment, safety and automation systems. For example, the instrument cluster display 114 may display vehicle information, such as speed and fuel level and a navigation application. In this way, the displays can show more than one application at a time. An application can be any infotainment, safety or automation function shown on a display. In some embodiments, certain applications are not shown on the instrument cluster display 114. For example, applications such as video playback and messaging applications may distract a driver. Therefore, in some embodiments, instrument cluster display 114 only displays applications that will not distract a driver.

In the illustrated embodiment center stack display 116 shows a weather application. This display can show any appropriate application. As described above, examples include, but are not limited to, a weather application, a music application, a navigation application, a climate control application, a messaging application and a video playback application. In some embodiments multiple applications can be displayed at once. Additionally, the vehicle interior 100 includes speakers 128 and 130. As described below, the speakers may be used to provide audio feedback to an occupant of the vehicle. The speakers may also be used to provide infotainment functions, such as music playback, navigation prompts. Additionally, the speakers may be used to provide vehicle status indications.

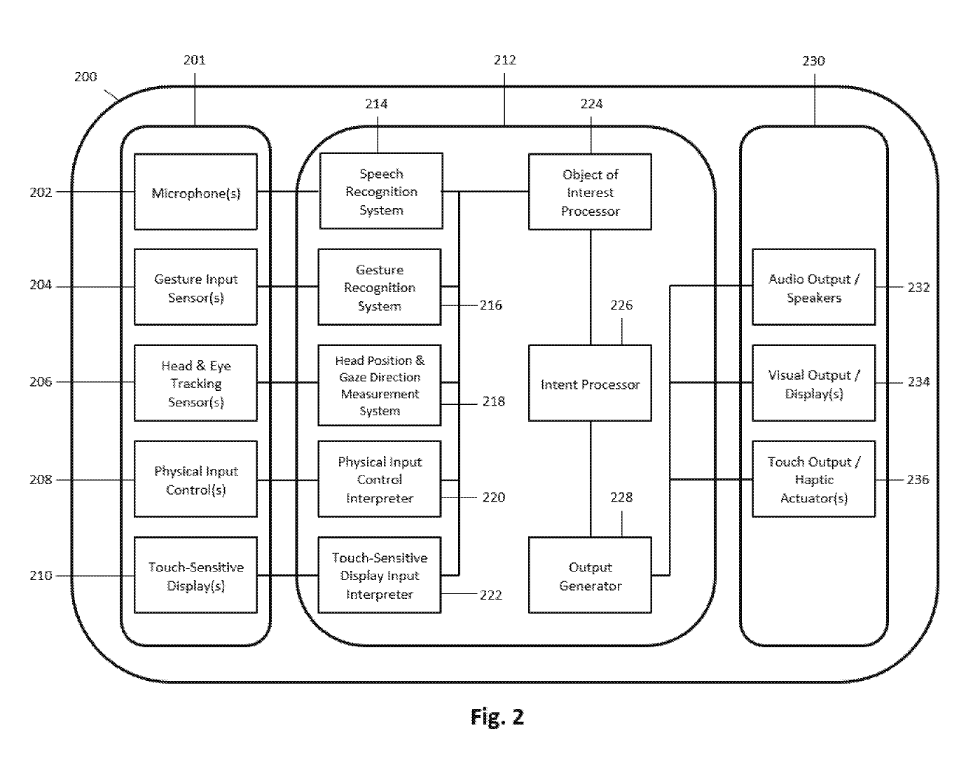

FIG. 2 is a system diagram depicting various components in a vehicle infotainment system 200. Inputs 201 to the system include one or more microphones 202, gesture input sensors 204, head and eye tracking sensors 206, physical input controls 208 and touch sensitive displays 210. A processing system 212 processes data from each of the inputs 201. The processing system 212 can be one or more general purpose or specialty processors. Each of the systems and functions in the processing system 212 can be implemented in software or hardware, using for example, an FPGA or ASIC. Each of the systems and functions in the processing system 212 can also be a combination of hardware and software.

A speech recognition system 214 connects to the microphones 202. The speech recognition system 214 can listen for a “wake” word or phrase. The wake word or phrase can be a name or phrase, such as “hello car.” After the speech recognition system 214 detects the wake word, the system listens for a command from a user. A command can be, for example, to put a specific application on a specific display. For example, a user could say the wake word followed by “put navigation on the center display.” After recognizing that command, the infotainment system would put a navigation application on the center stack display 116. Similar commands can be issued for the various combinations of applications and displays supported by the infotainment system.

A gesture recognition system 216 connects to the gesture input sensors 204. The gesture recognition system 216 recognizes when a user makes a gesture. For example, gesture recognition system 216 can recognize a user pointing at an object or motioning towards an object. If a user points or gestures towards one of the displays or physical input controls, the gesture recognition system 216 will recognize the gesture.

A head position and gaze direction measurement system 218 connects to the head and eye tracking sensors 206. The head position and gaze direction measurement system 218 determines where a user is looking. For example, if a user is looking at a display or physical input control, head position and gaze direction measurement system 218 will recognize where the user is looking. The head position and gaze direction measurement system 218 can also determine that the user is not looking at part of the vehicle infotainment system 200. For example, a user may be looking at the windshield, the rear-view mirror, side view mirror, shifter knob, etc.

A physical input control interpreter 220 connects to the physical input controls 208. The physical input control interpreter 220 determines if a user is interacting with or touching one of the physical input controls 208. For example, if a user is turning a knob or touching a surface, the physical input control interpreter 220 will determine which physical input control the user is interacting with, and the physical action the user is making.

A touch sensitive display input interpreter 222 connects to the touch sensitive displays 210. The touch sensitive display input interpreter 222 determines if a user is interacting with or touching one of the touch sensitive displays 210. For example, if a user is interacting with or touching one of the touch sensitive displays 210, touch sensitive display input interpreter 222 will determine which display the user is interacting with, and the touch gesture the user is making.

Each of the speech recognition system 214, gesture recognition system 216, head position and gaze direction measurement system 218, physical input control interpreter 220, and touch sensitive display input interpreter 222 connect to an object of interest processor 224. The object of interest processor 224 determines which object a user is interested in based on a combination of one or more of the input systems, speech recognition system 214, gesture recognition system 216, head position and gaze direction measurement system 218, physical input control interpreter 220, and touch sensitive display input interpreter 222.

For example, a user may initiate an interaction by activating the speech recognition system 214 using either a wake word or by touching a button on one of the touch sensitive displays 210 or physical input controls 208. The user can then speak a command, such as “Put navigation on that display” or “I want to see the weather on this display.” Additional exemplary commands include “move navigation from this display to that display” and “remove driver temperature from this knob.” As described above, in some embodiments any application can be used on any display.

If the user issues a complete voice command, such as “Put navigation on the center stack display,” then the object of interest processor 224 can determine from the speech recognition system 214 alone that the object of interest is the center stack display 116. However, if a user issues an ambiguous voice command, such as “Put navigation on that display”, then the object of interest processor 224 must determine which object the user is referring to. The object of interest processor 224 uses a combination of one or more of the input systems. For example, if a user issues an ambiguous voice command, such as “Put navigation on that display”, then the object of interest processor 224 determines which display the user is referring to based on the remaining input systems. If the gesture recognition system 216 determines that the user is pointing to a particular display, such as the center stack display 116, the object of interest processor 224 determines that the object of interest is the center stack display 116. Likewise, the head position and gaze direction measurement system 218 will determine if the user is looking at a particular display or physical input control when issuing a command. The object of interest processor 224 will then determine the display or physical input of interest based on the head position and gaze direction measurement system 218 input.

Similarly, the physical input control interpreter 220 determines if the user is touching or interacting with one of the physical controls 208. The object of interest processor 224 will then determine the physical input control is the object of interest based on the physical input control interpreter 220 input. Similarly, the touch sensitive display input interpreter 222 determines if the user is touching or interacting with one of the touch sensitive displays 210. The object of interest processor 224 will then determine one of the displays is the object of interest based on the touch sensitive display input interpreter 222.

The object of interest processor 224 can also determine the object of interest based on a user's position in the vehicle. Using a combination of the inputs, the object of interest processor 224 determines where the user issuing a command is located in the vehicle. If a user issues a command, such as “Put the weather on my display”, the object of interest processor 224 will determine that the object of interest is the display associated with the user. For example, if the user is in the front passenger location, the object of interest processor 224 will determine that the object of interest is the front passenger display 118. Additionally, the object of interest processor 224 may determine the object of interest relative to the position of the user. For example, a user may issue a command, such as “put weather on the display behind me” or “show navigation on the screen next to me.” In this example, based on the position of the user, the object of interest processor 224 would then determine that the object of interest is the display behind the user or the display next to the user.

The intent processor 226 determines the intent of a user's command. The following examples illustrate the use of the intent processor 226. However, any appropriate command can be issued by a user. For example, if a user issues an ambiguous voice command, such as “Put navigation on that display”, and the object of interest processor 224 determines through one or more of the remaining inputs that the user is referring to the front passenger display 118, then the intent processor 226 determines that the user wants to put the navigation application on the front passenger display 118. Similarly, a user can issue a command, such as “Make that knob control the volume.” The object of interest processor 224 determines through one or more of the remaining inputs that the user is referring to a particular physical input, such as 122. Then the intent processor 226 determines that the user wants to make physical input control 122 the volume control for the infotainment system.

The output generator 228 then generates the appropriate output based on the intent processor 226. For example, if the intent processor 226 determines that the user wants to put the navigation application on the front passenger display 118, then the output generator directs the navigation application to the front passenger display 118. The output generator 228 can provide information through various outputs 230 including audio output/speakers 232, visual output/displays 234 and touch output/haptic actuators 236. The touch output/haptic actuators 236 can be embedded in any of the displays or physical input controls to provide touch output to a user. The visual output/displays 234 can be any of the display in the vehicle. The audio output/speakers 232 can be any or all of the speakers associated with the vehicle infotainment system.

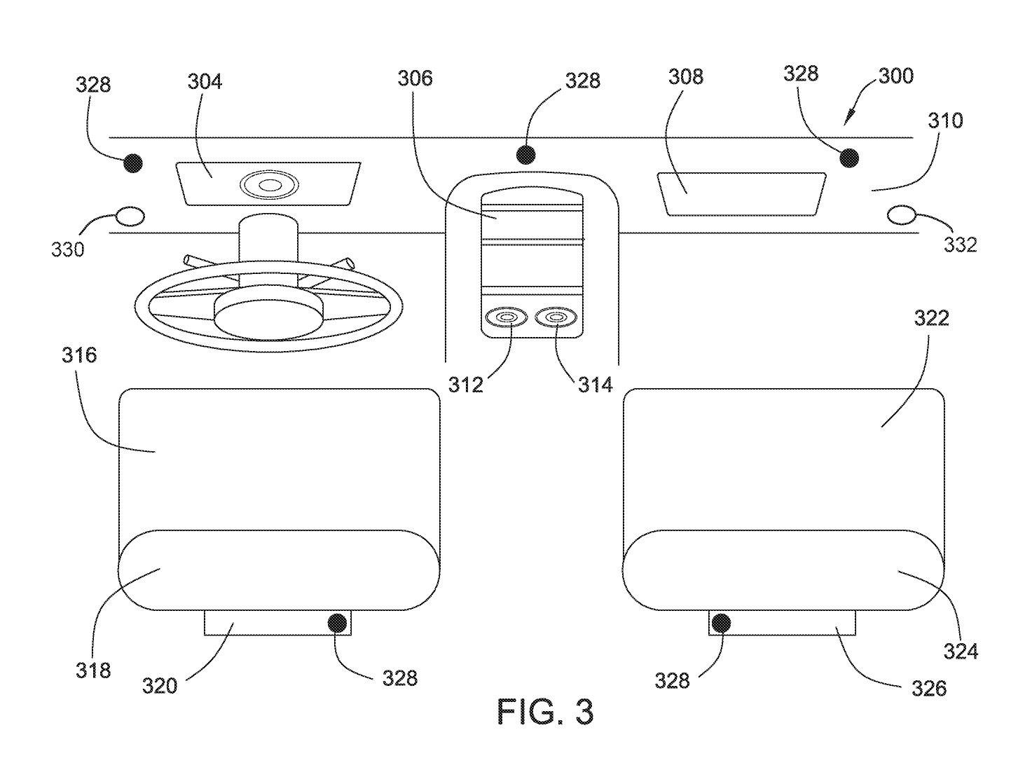

FIG. 3 is a plan view illustrating a vehicle interior 300 including an infotainment system. The vehicle includes steering wheel 302 and dashboard 310. Various displays including instrument cluster display 304, center stack display 306, and front passenger display 308 are included. Physical input controls 312 and 314 are also included. In the illustrated embodiment, driver seat 316 including driver seat back 318 is shown. Likewise, front passenger seat 322 including front passenger seat back 324 is illustrated. A first rear passenger display 320 is mounted to driver seat back 318 and a second rear passenger display 326 is mounted to front passenger seat back 324. As described above in some embodiments, any of the displays can show any application. In some embodiments, certain applications, such as video playback, are prevented from being shown on the instrument cluster display 304.

Sensors 328 include the various inputs 201 discussed above. As described above, the sensors 328 may include one or more microphones 202, gesture input sensors 204, head and eye tracking sensors 206, physical input controls 208 and touch sensitive displays 210. While the illustrated embodiment shows five sensors, various numbers of sensors can be used. Additionally, in some embodiments all sensors 328 do not include all inputs. For example, there may be more sensor locations with microphones then gesture input sensors. Additionally, in some embodiments, the placement of various sensors will vary. Microphones, gesture input sensors, and head and eye tracking sensors may be put in the same locations as illustrated, but may also be put in various locations. The location of the sensors within a vehicle will vary. Additionally, the vehicle interior 100 includes speakers 128 and 130 for providing audible information and feedback associated with the vehicle and infotainment system.

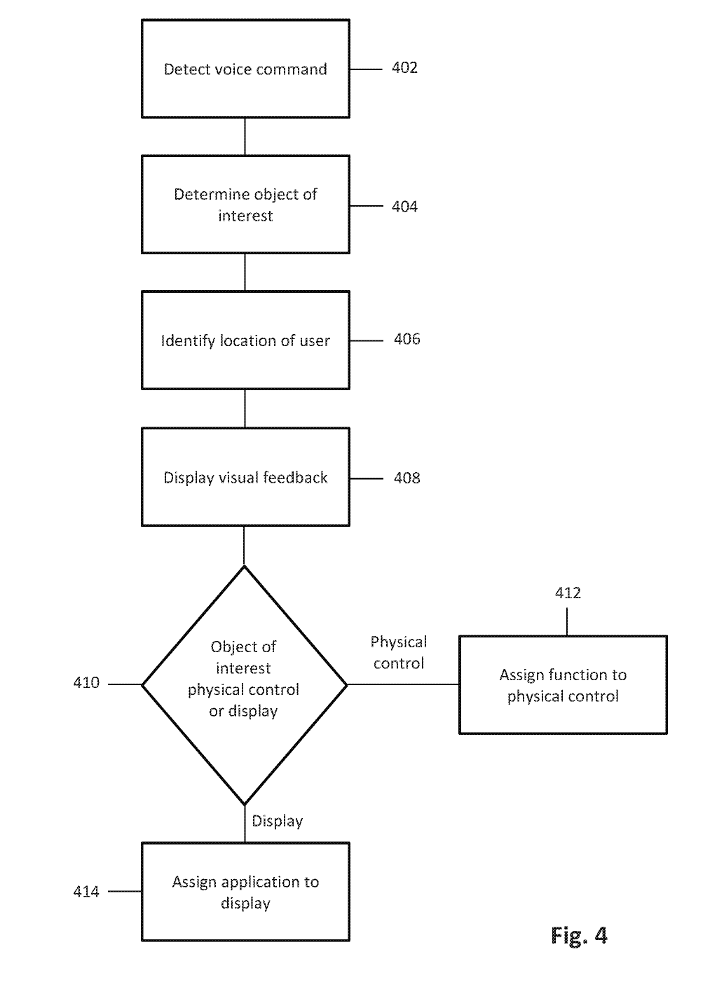

FIG. 4 is a flowchart illustrating an exemplary method for controlling a vehicle infotainment system. The method can be implemented using the hardware and software described above. The hardware may include a plurality of touch sensitive displays, a speaker system, at least one physical input control, a plurality of microphones, a gesture input system, a head and eye tracking system, and a computing processing system.

At step 402, the system detects a voice command using the plurality of microphones. The voice command may be preceded by a wake word or phrase. Alternatively, a physical or virtual button on a display may be pressed to indicate that a voice command will be spoken by a user. At step 404, the system determines an object of interest from the voice command. The object of interest can be one or more of the touch sensitive displays or one or more of the physical input controls. As described above, the system may determine the object of interest using an object of interest processor 224 connected to speech recognition system 214, gesture recognition system 216, head position and gaze direction measurement system 218, physical input control interpreter 220, and touch sensitive display input interpreter 222. The object of interest is determined based on a combination of the voice command and inputs from the remaining systems and interpreters. The object of interest is generally one of the displays or one of the physical input controls.

At step 406, the system identifies the location of the user. The location of the user can be determined using one or more of the inputs, such as microphones 202, gesture input sensors 204, head and eye tracking sensors 206, physical input controls 208 and touch sensitive displays 210. The system can use the combination of inputs to identify where the user issuing the command is located within the vehicle. For example, if a user is touching a display, such as the front passenger display, when saying a command, such as “Put the weather here”, the system will determine that the user is in the front passenger seat. Likewise, using the other sensors, the system can determine where a user issuing commands is located.

At step 408, the system displays a visual feedback of the voice command on the display associated with the position of the user in the vehicle. For example, if the user is in the front passenger seat, the system will display a visual feedback relating to the command on the front passenger display. The visual feedback can be a requested application appearing on the requested display. Alternatively, the feedback can be a text label indicating that the system is performing the requested action. In some embodiments, the system provides a non-verbal sound or speaks the feedback using the infotainment system. In some embodiments, the system provides both visual feedback and audio feedback. In still other embodiments, haptic feedback is provided through one of the displays or physical input controls.

At step 410, the system determines if the object of interest is a physical control or a display. If the object of interest is a physical control, at step 412 the system performs the requested action, such as assigning a particular function to the physical control. Example functions that can be assigned include temperature control, volume control, and zoom control for applications such as navigation. Other functions can also be assigned as appropriate. If the object of interest is a display, the system performs the requested action, such as showing an application on the display. In some embodiments, only one application is shown on a display at a time. In other embodiments multiple applications can be shown. For example, a user could say a command, such as “Put music on the right half of the center stack display.” In this way multiple applications can appear on a single display.

The object of interest processor 224 and the intent processor 226 are able to understand whether the user's requested action can be appropriately carried out on the object of interest. For example, if a user says, “put the navigation application on this knob”, the system will provide alternative guidance such as “sorry, but you can't display navigation on a knob.” In some embodiments, the intent processor 226 processor will recognize that the user wants to assign a relevant function to a physical input control based on the displayed application. For example, in some embodiments, if a user says, “put the navigation application on this knob”, the system will assign the zoom control function to the appropriate physical input control.

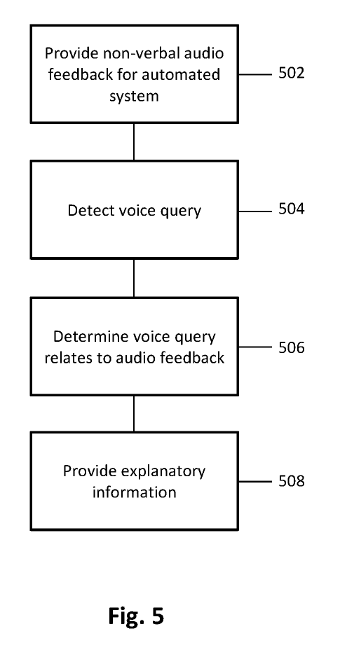

FIG. 5 is a flowchart illustrating an exemplary method for querying a vehicle infotainment system. Vehicles contain increasingly complex safety and automation systems. Such systems include lane departure warning systems, forward collision warning systems, driver drowsiness detection systems, and pedestrian warning systems. Traditional vehicle systems such as door open systems, and engine warning systems also provide information to vehicle occupants. The infotainment system described above can be used to provide explanatory information to vehicle occupants regarding particular vehicle feedback.

For example, at step 502, the vehicle provides non-verbal audio feedback for one of the onboard safety, automation or other vehicle systems. For example, the vehicle may issue a particular noise, such as a beep, tone, or earcon. At step 504 the system detects a voice command using the plurality of microphones. For example, the command could be “What was that?” At step 506, based on context and the recently issued audio feedback, the object of interest processor determines that the user is asking about the audio feedback. The system will keep track of at least the previous audio feedback. At step 508, the system provides an audio explanation of the audio feedback. For example, the system may speak over the speakers “That was a lane departure warning” or show a textual notification indicating lane departure warning on a display.

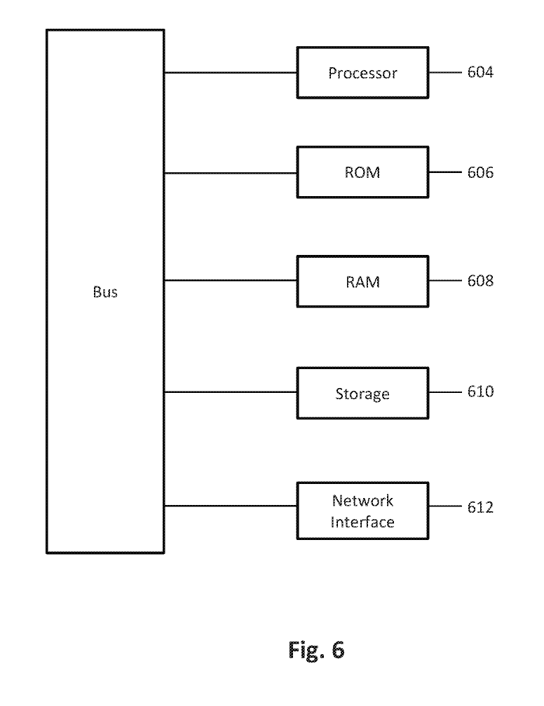

FIG. 6 is a block diagram of a processing system according to one embodiment. The processing can be used to implement the systems described above. The processing system includes a processor 604, such as a central processing unit (CPU) of the computing device or a dedicated special-purpose infotainment processor, executes computer executable instructions comprising embodiments of the system for performing the functions and methods described above. In embodiments, the computer executable instructions are locally stored and accessed from a non-transitory computer readable medium, such as storage 610, which may be a hard drive or flash drive. Read Only Memory (ROM) 606 includes computer executable instructions for initializing the processor 604, while the Random Access Memory (RAM) 608 is the main memory for loading and processing instructions executed by the processor 604. The network interface 612 may connect to a cellular network or may interface with a smartphone or other device over a wired or wireless connection. The smartphone or other device can then provide the processing system with internet or other network access.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An infotainment system for a vehicle, comprising:
a plurality of touch sensitive displays;
a speaker system;
at least one physical input control;
a plurality of microphones;
a gesture input system;
a head and eye tracking system;
a computing system connected to the plurality of touch sensitive displays, the physical input control, the microphones, the gesture input system and the head and eye tracking system, the computing system comprising a processor and a computer readable medium storing computer executable instructions thereon, that when executed by the processor, perform the following steps:
detecting a voice command received by the plurality of microphones;
determining an object of interest by performing at least one of:
detecting a user's touch input on at least one of the physical input control and the touch sensitive displays;
identifying, with the gesture input system, a direction of a gesture made by the user;
identifying, with the head and eye tracking system an object toward which the eye gaze position of the user is directed;
identifying, by the voice command, the object upon which the user intends to take action;
identifying, with at least one of the plurality of touch sensitive displays, the physical input control, the microphones, the gesture input system and the head and eye tracking system a location of the user within the vehicle; and
displaying, on the touch sensitive display proximate to the user, a visual feedback to the voice command.

2. The infotainment system of claim 1, wherein the computer readable medium further stores instructions that when executed by the processor, perform the following steps:
providing, with the speaker system, audio feedback relative to an automated vehicle system;
detecting a voice query received by the plurality of microphones;
determining that the voice query relates to the audio feedback; and
providing, with the speaker system, explanatory information related to the audio feedback.

3. The infotainment system of claim 2, wherein the computer readable medium further stores instructions that when executed by the processor, perform the following steps:
displaying, on the touch sensitive display proximate to the user, visual explanatory information related to the audio feedback.

4. The infotainment system of claim 1, wherein the computer readable medium further stores instructions that when executed by the processor, perform the following steps:
determining that the object of interest is the physical input control; and
assigning a function to the physical input control based on the voice command.

5. The infotainment system of claim 4, wherein the computer readable medium further stores instructions that when executed by the processor, perform the following steps:
displaying on a physical input control display, an indication of the function assigned to the physical input control.

6. The infotainment system of claim 1, wherein the computer readable medium further stores instructions that when executed by the processor, perform the following steps:
determining that the object of interest is one of the touch sensitive displays; and
displaying an application on the touch sensitive display of interest based on the voice command.

7. The infotainment system of claim 6, wherein the touch sensitive display of interest can display at least two applications and the computer readable medium further stores instructions that when executed by the processor, perform the following steps:
displaying a second application on the touch sensitive display of interest based on the voice command.

8. The infotainment system of claim 1, wherein the computer readable medium further stores instructions that when executed by the processor, perform the following steps:
detecting, with the plurality of microphones, a wake-up voice command; and
wherein after detecting the wake-up voice command, the system performs the detecting a voice command received by the plurality of microphones step.

9. The infotainment system of claim 8, wherein the computer readable medium further stores instructions that when executed by the processor, perform the following steps:
after detecting the wake-up voice command, providing at least one of:
providing with the speaker system an audible feedback that the system is ready for a voice command; and
providing with at least one of the touch sensitive displays visual feedback that the system is ready for a voice command.

10. The infotainment system of claim 1, wherein the computer readable medium further stores instructions that when executed by the processor, perform the following steps:
detecting, with the physical input control, a wake-up command; and
wherein after detecting the wake-up command, the system performs the detecting a voice command received by the plurality of microphones step.

11. A computer readable medium storing computer executable instructions thereon, that when executed by a processor in an infotainment system comprising a plurality of touch sensitive displays, a speaker system, at least one physical input control, a plurality of microphones, a gesture input system, a head and eye tracking system and a computing system connected to the plurality of touch sensitive displays, the speaker system, the physical input control, the microphones, the gesture input system and the head and eye tracking system, perform the following steps:
detecting a voice command received by the plurality of microphones;
determining an object of interest by performing at least one of:
detecting a user's touch input on at least one of the physical input control and the touch sensitive displays;
identifying, with the gesture input system, a direction of a gesture made by the user;
identifying, with the head and eye tracking system, an object toward which the eye gaze position of the user is directed;
identifying, by the voice command, the object upon which the user intends to take action;
identifying, with at least one of the plurality of touch sensitive displays, the physical input control, the microphones, the gesture input system and the head and eye tracking system a location of the user within the vehicle; and
displaying, on the touch sensitive display proximate to the user, a visual feedback to the voice command.

12. The computer readable medium of claim 11, which further stores instructions that when executed by the processor, perform the following steps:
providing, with the speaker system, non-verbal audio feedback relative to an automated vehicle system;
detecting a voice query received by the plurality of microphones;
determining that the voice query relates to the audio feedback; and
providing, with the speaker system, explanatory information related to the audio feedback.

13. The computer readable medium of claim 12, which further stores instructions that when executed by the processor, perform the following steps:
displaying, on the touch sensitive display proximate to the user, visual explanatory information related to the audio feedback.

14. The computer readable medium of claim 11, which further stores instructions that when executed by the processor, perform the following steps:
determining that the object of interest is the physical input control; and
assigning a function to the physical input control based on the voice command.

15. The computer readable medium of claim 1, which further stores instructions that when executed by the processor, perform the following steps:
determining that the object of interest is one of the touch sensitive displays; and
displaying an application on the touch sensitive display of interest based on the voice command.

16. The computer readable medium of claim 11, which further stores instructions that when executed by the processor, perform the following steps:
providing, with the speaker system, an audible feedback to the voice command.

17. The computer readable medium of claim 15, wherein the touch sensitive display of interest can display at least two applications and the computer readable medium further stores instructions that when executed by the processor, perform the following steps:
displaying a second application on the touch sensitive display of interest based on the voice command.

18. The computer readable medium of claim 11, which further stores instructions that when executed by the processor, perform the following steps:
detecting, with the plurality of microphones, a wake-up voice command; and
wherein after detecting the wake-up voice command, the system performs the detecting a voice command received by the plurality of microphones step.

19. The computer readable medium of claim 11, which further stores instructions that when executed by the processor, perform the following steps:
detecting, with the physical input control, a wake-up command; and
wherein after detecting the wake-up command, the system performs the detecting a voice command received by the plurality of microphones step.

20. A method of operating an infotainment system for a vehicle, the infotainment system comprising a plurality of touch sensitive displays, a speaker system, at least one physical input control, a plurality of microphones, a gesture input system, a head and eye tracking system and a computing system connected to the plurality of touch sensitive displays, the speaker system, the physical input control, the microphones, the gesture input system and the head and eye tracking system, the method comprising:
detecting a voice command received by the plurality of microphones;
determining an object of interest by performing at least one of:
detecting a user's touch input on at least one of the physical input control and the touch sensitive displays;
identifying, with the gesture input system, a direction of a gesture made by the user;
identifying, with the head and eye tracking system, an object toward which the eye gaze position of the user is directed;
identifying, by the voice command, the object upon which the user intends to take action;
identifying, with at least one of the plurality of touch sensitive displays, the physical input control, the microphones, the gesture input system and the head and eye tracking system a location of the user within the vehicle; and
displaying, on the touch sensitive display proximate to the user, a visual feedback to the voice command.
